(19) United States
(12) Patent Application Publication
(10) Pub. No.: US 2025/0183706 A1
(43) Pub. Date: Jun. 5, 2025

(54) WIRELESS AUTOMATIC TRANSFER SWITCHING

(71) Applicant: Renewable Systems Innovations Inc., American Fork, UT (US)

(72) Inventors: Keith S. Johnson, American Fork, UT (US); Dallas K. Johnson, Morgan, UT (US)

(21) Appl. No.: 18/842,691

(22) PCT Filed: Feb. 28, 2023
(86) PCT No.: PCT/US2023/014180

§ 371 Date: Aug. 29, 2024

Related U.S. Application Data
(60) Provisional application No. 63/315,447, filed on Mar. 1, 2022.

(51) Int. Cl. H02J 9/06; H02J 13/00

(52) U.S. Cl. CPC H02J 9/068; H02J 13/00002; H02J 13/00036

(57) ABSTRACT

An electrical power and switching apparatus and related methods with internal mechanically held-latching contacts and electronics encompassing smart wireless Automatic Transfer Switching (ATS), solid state switching, control, load management and monitoring, that are formed into the shape of a typical mechanically tripping and manually resetting circuit breaker so the apparatus can easily be stabbed or bolted into a typical circuit breaker panels busbars and retention slots for convenient adaptability or mating with an electrical panel.

### CROSS-REFERENCE TO RELATED APPLICATIONS

This application claims priority to U.S. Provisional Application No. 63/315,447 filed on 1 Mar. 2022, the disclosure of the foregoing application is incorporated herein in its entirety by this reference.

### TECHNICAL FIELD

This application relates generally to switching between one or more sources of electrical power using one or more electrical power switching apparatuses.

### BACKGROUND

Electrical power demands are increasing in many homes, businesses, and work sites. Many appliances, tools, generators, or other items coupled to an electrical system require a large electrical load to operate. Existing electrical systems may not be up to the load demands of the appliances, tools, generators, or the like.

### BRIEF DESCRIPTION OF THE SEVERAL VIEWS OF THE DRAWINGS

The disclosure will be readily understood by the following detailed description in conjunction with the accompanying drawings, wherein like reference numerals designate like structural elements, and in which:

FIG. 1 illustrates a side view of an electrical power switching apparatus, in accordance with some embodiments.

FIG. 2 shows a front view of an electrical power switching apparatus, in accordance with some embodiments.

FIG. 3A illustrates an electrical power switching apparatus that includes an internal a physical mechanical latching relay, in accordance with some embodiments.

FIG. 3B illustrates an electrical power switching apparatus that includes an internal solid state relay, in accordance with some embodiments.

FIG. 4 illustrates an electrical power switching apparatus installed on an electrical distribution panel, in accordance with some embodiments.

FIG. 5 illustrates an electrical power switching apparatus coupled to a contactor, in accordance with some embodiments.

FIG. 6 illustrates a set of electrical power switching apparatuses, in accordance with some embodiments.

FIG. 7 illustrates a flowchart of one possible example of the cycling of loads and sources by electrical power switching apparatuses, in accordance with some embodiments.

FIG. 8 illustrates an embodiment where multiple electrical power switching apparatuses are connected to an electrical power switching apparatus serving as a hub.

FIG. 9 illustrates a simplified block diagram of an electrical power switching apparatus according to embodiments disclosed herein.

FIG. 10 illustrates a flowchart of a method of automatically switching an electrical load from one circuit to another circuit.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure relates to an electrical power and switching apparatus and related methods with internal mechanically held-latching contacts, solid state relay switching, and electronics encompassing smart wireless Automatic Transfer Switching (ATS), control, load management and monitoring, that are formed into the shape of a typical mechanically tripping and manually resetting circuit breaker so the apparatus can easily be stabbed or bolted into a typical circuit breaker panels busbars and retention slots for convenient adaptability or mating. The apparatus may not derive its power from the panel's busbars the same as a circuit breaker does for downstream overcurrent protection, rather the apparatus mates with or is wired to the circuit breakers' overcurrent protected load side screw terminal(s) as the circuit breaker already derives its power from the busbars for providing predetermined-amperage-limiting circuit-breaking-protection for downstream loads. The electrical power switching apparatus mates with and gives greater beneficial functions to circuit breakers already installed in breaker panels providing overcurrent protection limits to downstream loads such as for lighting and refrigerators. Adding downstream wireless smart power to loads after the apparatus is mated with circuit breakers may provide additional safe ground fault circuit interruption protection power to loads, additional safe arc fault circuit interruption protection power to shared loads with additional mechanically held-latching automatic transfer switching to shared loads, additional monitoring for shared loads, additional power measurements for shared loads, additional reporting of shared load power consumption and additional load shedding control with ideal adaptability to typical circuit breaker loads shared with or mated with the electrical power switching apparatus for additional ideal downstream function benefits.

There are hundreds of millions of typical mechanically-tripping-manually-resettable-circuit-breakers installed in distribution panels in homes and business that could benefit from additional intelligent downstream protection, switching, monitoring, management and control for loads the electrical power switching apparatus provides. Additionally, there are hundreds of millions of power sources from recreational vehicles generators, portable generators, photovoltaic power, stored battery power, wind power and other power sources that do not easily connect to building panel distribution systems for convenient use. The electrical power switching apparatus solves this power management and source connection problem with convenience and simplicity by easily adapting to both utility and other power sources for adding wireless intelligently controlled multi-power-source switching or transferring, control, monitoring and load management, while meeting mechanically held utility grid isolation safety requirements.

Most regulating jurisdictions and codes require mechanically held automatic transfer switches to be used when switching a utility source's electricity to another source for emergency or other back up power reasons, so that the utility grid can be mechanically isolated and protected from unwanted back fed electricity when the power grid is down and when emergency backup power is originating from a different then utility power source.

The electrical power switching apparatus is an automatic transfer switching device or solid state switching device that easily connects to most any typical industry power distribution panel made by manufacturers such as GE, WESTINGHOUSE, ITE, SIEMANS, CUTLER HAMMER, SQUARE-D and others.

The body of the electrical power switching apparatus may not derive its power directly from a typical breaker panels' busbars like a circuit breaker, but rather from a circuit breaker in the same panel or other panels serving a typical utility load like lighting, receptacles etc. The electrical power switching apparatus can also derive its power from an emergency generator, emergency solar or battery source for the purpose of serving emergency circuits or loads when utility power is off or interrupted. The electrical power switching apparatus can switch a load off to the emergency power position when emergency power is off. Alternatively, the electrical power switching apparatus can switch power off to its utility position when emergency power is on while utility power is off. This automatic wireless switching “on and off” between the two power sources allows for the load-shedding of power in order to save on demand power and demand rates and/or to prioritize power within the emergency generating source's electrical power generating limits. Load-shedding allows for the use of smaller portable generators, including recreational vehicle generators that cannot simply be plugged into a homes' critical emergency circuits without load-shedding or the generator will be damaged, shut down, or trip out.

Additional benefits may be fuel savings by utilizing less fuel consuming smaller generators while getting the desired benefits of electricity fed to critical circuits with controlled priority and load-shedding. Because most electrical loads operate with uncontrolled cycling, like air conditioning, furnaces, refrigerators, freezers, switched lighting loads and more, the electrical power switching apparatus may control the cycling prioritized in order to avoid all the devices and appliances starting at the same time. Because starting loads and uncontrolled cycling loads can also over-load the electrical grid causing blackouts, a given utility can accesses an electrical power switching apparatus via WIFI and priority load-shed its utility power and/or utilize a supplemental emergency generator, supplemental solar and/or supplemental battery storage standby electricity energy when utilizing the switched isolating neutral option of the electrical power switching apparatus. Isolated neutrals are required when two or more power generating sources are feeding power into the same utility distribution panels loads at the same time. When and if the utility grid has a blackout condition, the electrical power switching apparatus can use load-shedding or supplemental energy to allow the emergency power system of choice to operate desired loads with a smaller than normal system saving fuel, demand charges and original installation costs. Other benefits include the multiple uses of portable generators including R.V. generators, less maintenance costs because of generator supervision and automatic generator exercising.

Multiple wirelessly controlled electrical power switching apparatuses may be used and conveniently placed in typical industry breaker panels to monitor, control, transfer power, charge batteries and switch as needed for priority circuit load-shedding and/or supplemental power. The electrical power switching apparatus can incorporate the use of photovoltaic (P.V.) arrays that use integral or separate grid syncing inverters that are normally required to turn off P.V. power when grid power is off. The electrical power switching apparatus can automatically switch the P.V. power to the emergency power system inverter/battery charging system allowing the P.V. inverter system to sync with emergency power during emergency power use, otherwise the grid syncing solar array cannot be used which is a disappointment to many users. The electrical power switching apparatus may be configured to work with 1 phase, 2 phase and 3 phase circuit breaker panel distribution systems. Such circuit breakers panel systems can be optimized by managing the load with a connected electrical power switching apparatus for loads originally fed directly from a panel's standard circuit breakers.

The electrical power switching apparatus may incorporate the charging of Electrical Vehicles (EV) as well as utilizing the EV batteries for emergency power when utility power is interrupted thereby adding emergency backup power functions from an electric vehicle normally charging from utility or other power sources.

These and other embodiments are discussed below with reference to the figures. The detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

The phrase “coupled to” is broad enough to refer to any suitable coupling or other form of interaction between two or more entities. Thus, two components may be coupled to each other even though they are not in direct contact with each other. For example, two components may be coupled to one another through an intermediate component.

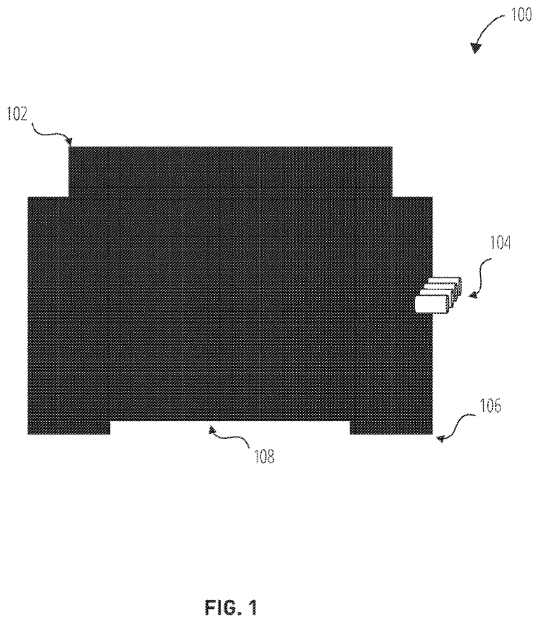

FIG. 1 illustrates a side view of an electrical power switching apparatus 100, in accordance with some embodiments. The electrical power switching apparatus 100 may be used to monitor, measure and manage power usage of a circuit of an electrical system. In some embodiments, the electrical power switching apparatus 100 may identify any abnormalities or changes in the electrical system.

The electrical power switching apparatus 100 may comprise a housing that is sized and shaped to fit into an electrical panel. The housing may include mechanically held-latching contacts that are formed into the shape of busbar connectors of a mechanically tripping and manually resetting circuit breaker so the electrical power switching apparatus 100 is sized and shaped to stab or bolt into a circuit breaker panel to contact an electrical panel. These mechanically held-latching contacts may include a slot, tab, clip, and/or screw. The electrical power switching apparatus 100 may be in the same form as a circuit breaker, and therefore secure to a busbar of a circuit panel in a similar way.

For example, the electrical power switching apparatus 100 may include slots that are used to secure it to the tabs of a busbar. These slots may be located on the sides or bottom of the electrical power switching apparatus 100. When the electrical power switching apparatus 100 is inserted onto a busbar or mounting bracket, the tabs or clips on the busbar will engage with the slots or notches on the electrical power switching apparatus 100, creating a secure and stable connection. Alternatively, the electrical power switching apparatus 100 may include tabs or clips located on the sides or bottom of the breaker that are designed to fit into corresponding slots or notches on the busbar or a mounting bracket.

In the illustrated embodiment, the electrical power switching apparatus 100 may have corner slots 106 to stab into multiple brands of distribution panels, busbars and mounting brackets. In some embodiments, the electrical power switching apparatus 100 may bolt onto the distribution panel. In some embodiments, the electrical power switching apparatus 100 may include one or more adapter plates to modify the connection mechanism to allow the electrical power switching apparatus 100 to connect to distribution panels with different configurations. The bottom of the electrical power switching apparatus 100 may have a Din Rail mounting slot 108 for optional mounting of the electrical power switching apparatus 100 into control cabinets or junction boxes. The electrical power switching apparatus 100 may have a raised top 102 that may fit through distribution panel cover plates and provide space for antenna communication between itself, a hub, a user device, and other control devices.

The electrical power switching apparatus 100 does not receive power directly from the busbars of the distribution panel. As such, the corner slots 106 may be a non-conductive material used for securing the electrical power switching apparatus 100 to the distribution panel rather than supplying the electrical power switching apparatus 100 with power. By using a non-conductive connection with the panel, the electrical power switching apparatus 100 may not need to be configured according to the design standards of a single panel manufacturer, thereby making the installation of the electrical power switching apparatus 100 more flexible and universal. While the illustrated embodiment does not receive power from the busbars, other embodiments may receive power directly from the busbars.

Instead, the electrical power switching apparatus 100 may have electrical interfaces (e.g., wiring terminals 104) that may connect to a circuit breaker to receive power, and connect to the load of the circuit breaker. The electrical power switching apparatus 100 may be electrically positioned between a circuit breaker and the load of the circuit breaker. The electrical power switching apparatus 100 may control whether the power from the circuit breaker is applied to the load. For example, a first electrical interface may couple with an output of a circuit breaker to receive power from the circuit breaker. A second electrical interface may be coupled to a load associated with the circuit breaker. A relay may be electrically coupled to the first electrical interface and the second electrical interface, and processing circuitry may control the relay to selectively apply the power from the circuit breaker to the load. In some embodiments, additional electrical interfaces may be used to couple the electrical power switching apparatus 100 to more power sources. A switch may be used to mechanically change between the sources of power.

The electrical power switching apparatus 100 may include a GFCI/ARC fault reset button which may be tripped based on abnormalities or changes in the electrical system. In the event of a trip, the electrical power switching apparatus 100 may send a notification to a user (e.g., via a mobile application). The user may inspect the circuit for problems and push the GFCI/ARC fault reset button to cause power to be applied again to the load.

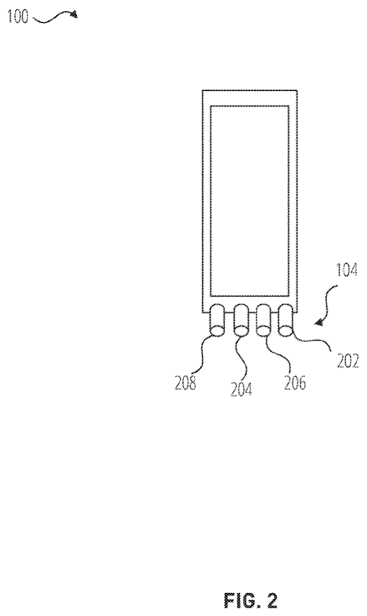

FIG. 2 shows a front view of an electrical power switching apparatus 100, in accordance with some embodiments. The electrical power switching apparatus 100 may bolt into or stab into electrical distribution panels and secure its position in the panel's busbars with a non-conductive connection. The front of the electrical power switching apparatus 100 is made to fit the breaker interlocking parts located in distribution panels.

The electrical power switching apparatus 100 may include integral smart circuitry with integrated microprocessor, electronics, antenna, and a mechanical latching relay for automatic power transfer switching (e.g., switching from utility power to supplemental power). The electrical power switching apparatus 100 may also include wiring terminals 104. The wiring terminals 104 may include a neutral wire terminal 202, a utility terminal 206, a common load terminal 204, and a supplemental power terminal 208.

The electrical power switching apparatus 100 is an apparatus that may use a common neutral reference (e.g., via neutral wire terminal 202) for powering its internal smart circuit board for converting AC to DC power. The neutral wire terminal 202 may be for circuit board power, Arc Fault Circuit Interruption (AFCI) and Ground Fault Circuit Interruption (GFCI) load protection. The utility terminal 206 may be normally closed and may be used for a utility power feed. The utility terminal 206 may be fed from a panel's circuit breaker sized for the common load. The common load terminal 204 may provide utility or emergency power to loads (e.g., furnaces, refrigerators, lighting, etc.) from either the utility terminal 206 or the supplemental power terminal 208. The supplemental power terminal 208 may be a normally open terminal to receive emergency/supplemental power from an inverter, generator, battery, or other power source. The supplemental power terminal 208 may be fed from a circuit breaker sized from the common load.

The electrical power switching apparatus 100 may use 2 phase power references for powering its internal circuit board for converting AC to DC power. The electrical power switching apparatus 100 may include GFCI and AFCI for protecting downstream circuit breaker loads. Thus, the electrical power switching apparatus 100 may increase the capacity of a circuit breaker that does not include GFCI and AFCI.

The electrical power switching apparatus 100 transfers power between normally open contact (N/O) terminals (e.g., supplemental power terminal 208), common contact terminals (e.g., common load terminal 204), and normally closed contact (NC) terminals (e.g., utility terminal 206). The electrical power switching apparatus may internally include one or more mechanically held latching relays for the purpose of the Automatic Transfer Switching of its mating circuit breaker loads between said common terminals and N/O and N/C terminals.

While the illustrated embodiment shows a single phase electrical power switching apparatus 100, the electrical power switching apparatus 100 may be adapted for other configurations. For example, the electrical power switching apparatus 100 may be configured with electrical interfaces to support one phase with neutral, two phase with no neutral, three phase with no neutral, one phase with switched neutral, two phase with switched neutral, or three phase with switched neutral. For these different configurations, additional wiring terminals (not pictured) may be included. Further, the size of the electrical power switching apparatus 100 may be changed for additional space ad to attach at more points on the busbars.

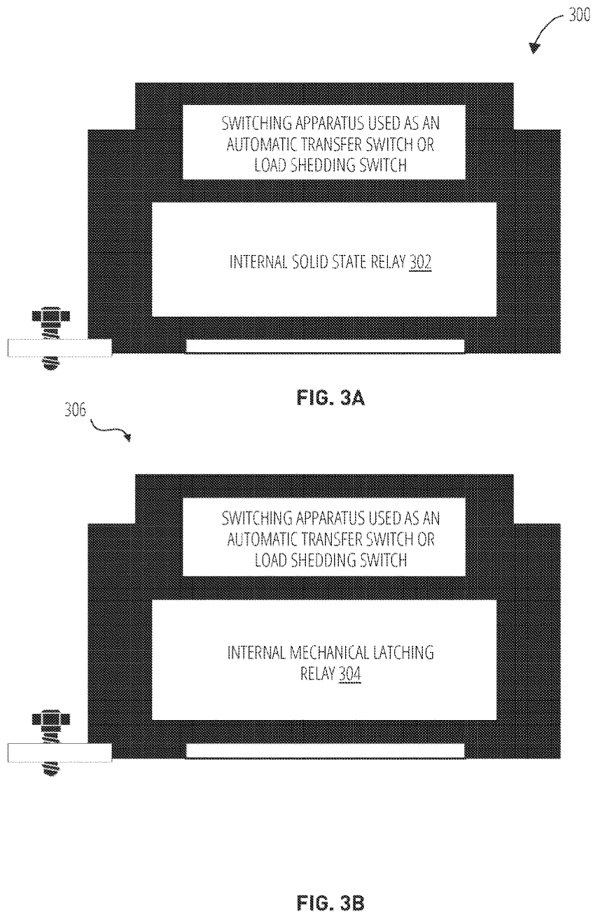

FIG. 3A and FIG. 3B illustrate possible embodiments of an electrical power switching apparatus. The electrical power switching apparatus may be used as an automatic transfer switch or as a load shedding switch.

FIG. 3A illustrates one embodiment, wherein the electrical power switching apparatus 300 may include an internal solid state relay 302. Possible types of solid state relays may include transformer relays, Opto-Isolator relays, capacitor replays, hall effect relays, and magnetoresistance relays. Solid state relays may be used as an electronic switching device that may switch on and off when an external control signal is applied to its control terminals. This may be completed without the use of a mechanical switch as the switching may be done with the use of semiconductors and electrical parts such as MOSFETS and Diodes. Solid State Relays may include a single MOSFET or diode or combination of the two. Multiple MOSFETs and diodes may also be put in parallel or series as to switch between different size loads and sources.

FIG. 3B illustrates another embodiment, wherein the electrical power switching apparatus 306 comprises a physical mechanical latching relay to conduct switching. A mechanical latching relay may include a physical switch that opens and closes depending on if a signal is provided at the control terminal. The latch may be open until a signal is given to the control terminals thus breaking the circuit or it may remain closed until a signal is given thus powering the circuit. The latching relay may maintain its position after switching thus performing a basic memory function. The latch may also release once there is no more signal. The control signal may contain information for the control terminals or it may be a simple voltage that if higher than a certain threshold, the switch may engage or disengage the latch.

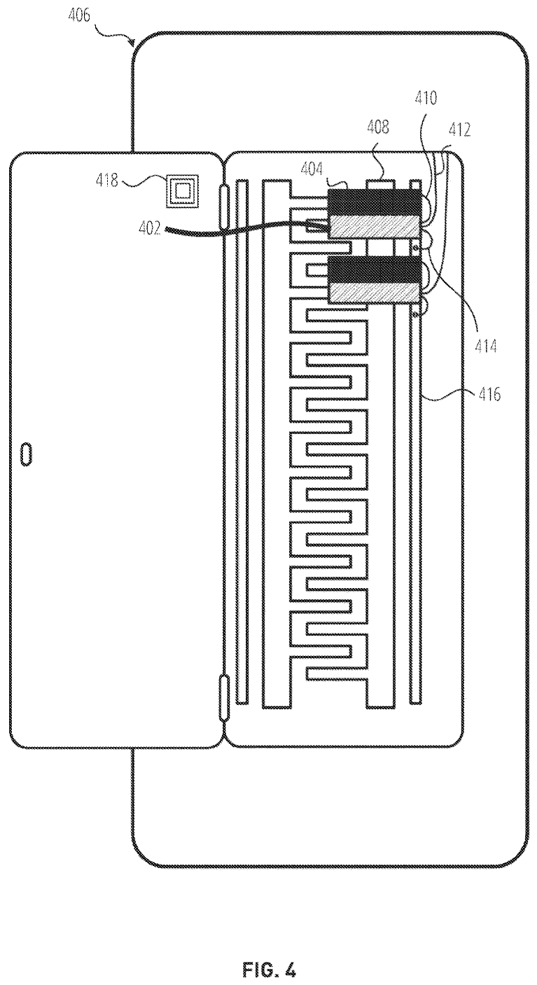

FIG. 4 illustrates an electrical power switching apparatus 402 installed on an electrical distribution panel 406. As shown, the electrical power switching apparatus 402 may be secured to a busbar 408 in a similar manner as a circuit breaker 404. However, while the circuit breaker 404 may derive its power from its connection with the busbar 408, the coupling mechanism of the electrical power switching apparatus 402 may be non-conductive and used to secure the electrical power switching apparatus 402 position rather than for power. In other words, the electrical power switching apparatus 402 may be attached the busbar 408 without being powered by the busbar, as the busbar 408 may only be used as structural support for the electrical power switching apparatus 402.

The electrical power switching apparatus 402 may be wired between the circuit breaker 404 and the load of the circuit breaker 404. For example, a first wire 410 may connect the output of the circuit breaker 404 to the electrical power switching apparatus 402. The electrical power switching apparatus 402 may receive power from the circuit breaker 404 via the first wire 410. Additionally, processing circuitry and other elements of the electrical power switching apparatus 402 may be powered with the energy from the circuit breaker 404. For example, the electrical power switching apparatus 402 may include an AC/DC converter that converts the power from AC to DC and then the circuitry may use the DC power. A second wire 412 may connect the electrical power switching apparatus 402 to a neutral bar 416. Further, a third wire 414 may connect the electrical power switching apparatus 402 to the load.

The electrical power switching apparatus 402 may be wired to the circuit breaker 404 without the need to take out the original circuit breakers or replace them for newer versions. If there is no room within the electrical distribution panel 406, wires may be ran to attach the circuit breaker 404 to the electrical power switching apparatus 402 in an external control box such as a control cabinet or a junction box, thus allowing flexibility within installation of the electrical power switching apparatus 402. A din rail may also be added to the original circuit breaker box to add a place to attach the electrical power switching apparatus 402.

The electrical power switching apparatus 402 may be sized and shaped to fit into and adapt to most electrical panels utilizing typical circuit breakers from manufactures such as: GE, WESTINGHOUSE, ITE, SIEMENS, CUTLER HAMMER, SQUARE-D and other circuit breaker panel manufacturers. The electrical power switching apparatus 402 can include internal electronics to provide circuit switching to a no power position when overloaded with amps above a preset limit and also add protection to a circuit breaker's load by adding GFCI and AFCI protection for a given circuit breaker 404 that previously only provided mechanically tripping and manual resetting functions. Because the electrical power switching apparatus 100 measures amps, volts and kW, the electrical power switching apparatus 402 can report faults and status conditions such as appliance overload conditions, maintenance needs and schedules, on and off conditions and accumulating watts for user privileges, via a wireless interface (e.g., WIFI).

The electrical distribution panel 406 can have two to three busbars (e.g., busbar 408) where the typical mechanically tripping and manual resetting circuit breakers (e.g., circuit breaker 404) attach to the busbars with integral conductive friction held metal clips or conductive bolted terminals, in order to make contact with the busbars for conducting single phase, two phase or three phase electricity through the circuit breaker(s) to a given load (e.g., lighting load or receptacle load).

A circuit breaker 404 that has tripped because of an overload problem should be inspected or evaluated for why it tripped, correct the tripping problem, and then after problem correction manually resetting the circuit breaker 404. This hands-on manual resetting helps to ensure a problem is corrected before power is fed again from the busbars through a given circuit breaker in order to avoid damage to equipment or a possible fire from a downstream loads short circuit or overload problem. The mechanical tripping and resetting of a circuit breaker 404 can be essential for safety, thus the electrical power switching apparatus 402 can be designed to enhance the features provided to existing circuit breaker loads that are already provided over current protection from corresponding circuit breakers.

The electrical power switching apparatus 402 can use a nonconductive body to hold itself to the busbar 408 by friction and/or a nonconductive fastened connection. For example, the electrical power switching apparatus 402 may secure to the busbar 408 in the same manner as a typical mechanically tripping and resettable circuit breaker (e.g., circuit breaker 404). The electrical power switching apparatus 402 may not derive electrical power from the busbars 408 as it is insulated from doing so.

The electrical power switching apparatus 402 may include a wireless interface that allows communication with an external device. However, the electrical distribution panel 406 may reduce wireless signal quality. A signal amplifier (e.g., wireless antenna 418) may be mounted through or on the circuit breaker panel cover for amplifying the signals to and from the electrical power switching apparatus 402. The wireless antenna 418 may send and receive signals to and from the electrical power switching apparatus 402. This wireless antenna 418 may attach to or through the metal panel cover and serve as an amplifier antenna for the internal antenna of the electrical power switching apparatus. The through the panel cover amplifier antenna may be used to overcome the metal in the panel cover blocking or impeding the signals from the antenna integrated with the electrical power switching apparatus 402.

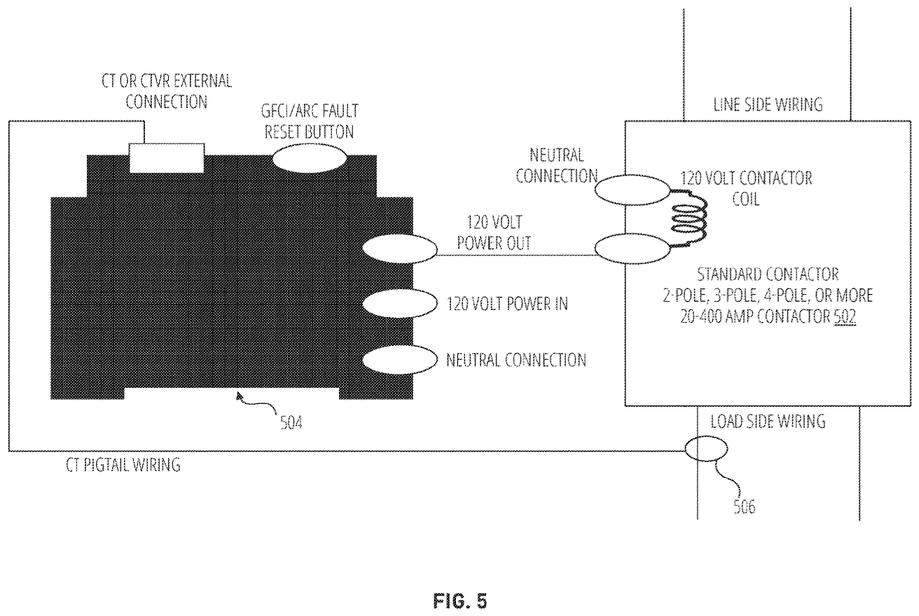

FIG. 5 illustrates an electrical power switching apparatus 504 coupled to a contactor 502, in accordance with some embodiments. The contactor 502 may have a higher amperage then what the electrical power switching apparatus 504 may supply or handle. The contactor 502 may be a 2-pole, 20-400 amp contractor. Within some embodiments, the electrical power switching apparatus 504 may contain a hard wired connection to a current transformer (e.g., CT or CTVR clamp 506) which may read the amps of the high amperage contactor and do necessary calculations within its microprocessor to configure itself to control the contactor 502 without supplying power. For example, the electrical power switching apparatus 504 may be used as a switch to turn on and off high amperage electronics such as a 20 horsepower pump or an entire circuit breaker panel without supplying this amount of power directly from the electrical power switching apparatus 504.

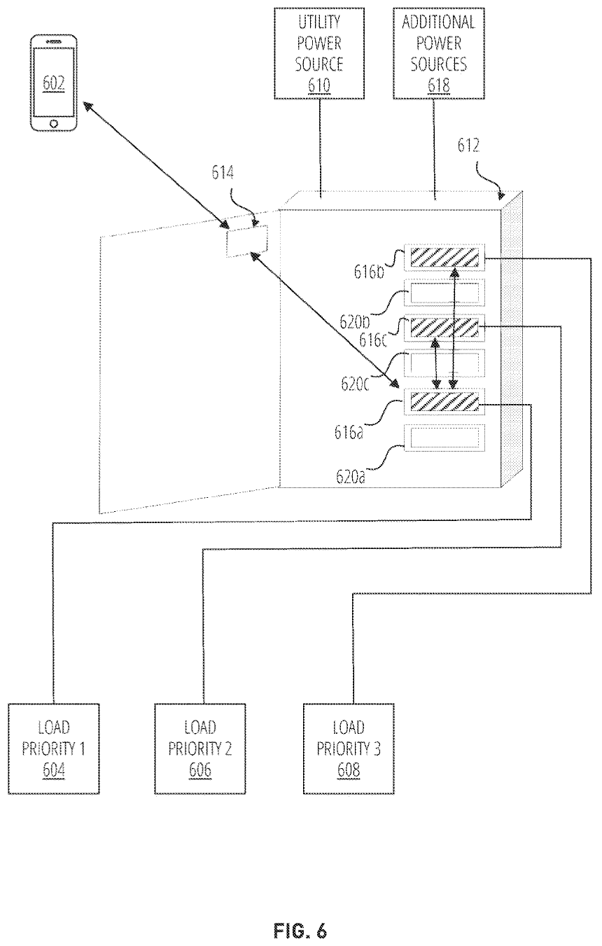

FIG. 6 illustrates a set of electrical power switching apparatuses (e.g., electrical power switching apparatus 616a, electrical power switching apparatus 616b, and electrical power switching apparatus 616c), in accordance with some embodiments. A corresponding set of circuit breakers (e.g., circuit breaker 620a, circuit breaker 620b, and circuit breaker 620c) may receive power from the utility power source 610 and provide that power to the set of electrical power switching apparatuses.

The electrical power switching apparatuses may be coupled to a set of electrical loads. The various loads may have different priorities (e.g., Load Priority 1 604, Load Priority 2 606, and Load Priority 3 608) that may be set by the user within an application on an external device 602. The priorities may signify which loads should merit attention over other loads during a load shedding scenario. Possible loads may include but are not limited to: light circuits, furnace circuits, refrigerator circuits, freezer circuits, heating elements, receptacle circuits, microwave circuits, charging circuits, washer and dryer circuits.

The load with a higher priority will be the prioritized load to receive power in the case of a brown out, black out or any general loss of electricity. The priority system is fluid as it may allow for the user to change which circuit has what priority as the need for each load changes with use. The electrical power switching apparatuses may shed certain loads with a lower set priority as to not trip any circuit breakers, or short any important electronics on a circuit. The electrical power switching apparatuses load shedding may also be used to match the amount of electricity and power being used to the amount of electricity being supplied by the utility or the other sources.

The circuit breaker box 612 may also be attached to one or multiple sources (e.g., utility power source 610 and additional power sources 618) that may provide electricity to the electrical system. The set of electrical power switching apparatuses may be able to switch between the power sources. For example, in the event of a power outage, a relay in the set of electrical power switching apparatuses may switch from being connected to the circuit breakers to being connected with the additional power sources 618. The user may also input the capacity of the sources manually into the application on the external device 602, the additional power sources 618 may provide the application with its capacity, or the electrical power switching apparatuses may measure the capacity and inform the application. Possible sources may include but are not limited to: utility electrical lines, portable generators, battery banks, solar panels, wind turbines, thermal generators, EV cars.

The electrical power switching apparatus 616a may communicate with the external device 602. A booster pass-through antenna 614 on the cover of the breaker box 614 may amplify signals to and form the electrical power switching apparatus 616a. Possible examples of external devices include a phone, laptop, tablet, computer, control box. The antenna 614 may work as an extender or booster to facilitate the pass through of signals through the circuit breaker box or other similar electrical control boxes. The passthrough antenna may not be needed if the a non-metallic cover lid is utilized by the circuit breaker panel. In some embodiments, such as the one shown, other electrical power switching apparatuses (e.g., electrical power switching apparatus 616b and electrical power switching apparatus 616c) may communicate with the external device 602 through a hub electrical power switching apparatus (e.g., electrical power switching apparatus 616a). In other embodiments, each of the electrical power switching apparatuses may communicate with the external device 602.

The electrical power switching apparatuses may measure many electrical values such as the highest power output and the real time power output for a load or input for a source. The electrical power switching apparatuses may use this data to determine if load shedding is needed based on the capacity of the source.

Within some embodiments, multiple sources may be connected to electrical power switching apparatuses thus allowing for the cycling of power sources during a power outage. For example, a battery bank may run out of charge and the electrical power switching apparatus may automatically cycle to another source such as a portable generator or a utility line to allow for the continued use of the higher priority loads without unnecessary use of fuel and resources. This source cycling may also be done manually by the user within the application. For example, the power from a source such as a generator may be turned off when the user notices that power is restored from the utility as to prevent excess fuel usage or reactive power being sent back to the utility.

The user may also manually turn off or turn on certain loads according to the current need and electrical capacity of the system. For example, the user may select certain loads in the application and turn the loads on and off. In some embodiments, loads may be cycled on and off depending on how long they are being used. In some embodiments, the user may use the application to set a timer as to how long a certain source or load is to be turned on or off for thus optimizing electricity usage if a load only needs to be on for a certain amount of time. One possible example of this is that the user may set a timer of five hours for their Christmas lights to remain on only during the night time hours or the user may only want a generator to run for three hours thus requiring a timer. Load shedding done by the electrical power switching apparatuses may be used to prevent a higher demand energy rate.

In some implementations of the electrical power switching apparatuses, multiple circuits can be running at the same time while utilizing different sources. For example, Load Priority 1 604 may be utilizing utility power source 610 while Load Priority 2 606 and Load Priority 3 608 may be utilizing additional power sources 618.

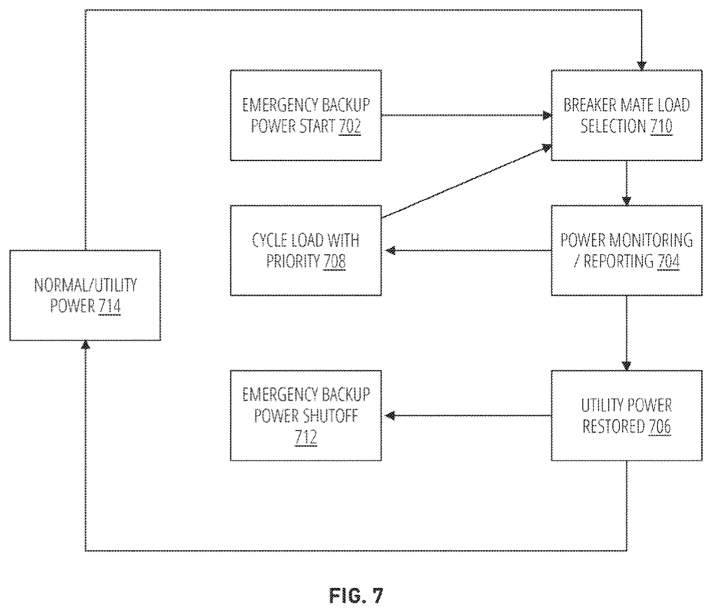

FIG. 7 illustrates a flowchart of one possible example of the cycling of loads and sources by electrical power switching apparatuses. For example, the electrical power switching apparatuses may use 714 normal or utility power source. The electrical power switching apparatuses may determine that an outage is affecting the utility power source, or that a higher demand charge is about to occur. The electrical power switching apparatuses may start 702 emergency backup power sources, and determine 708 a load cycle based on the load priority. Based on the capacity of the backup power sources and the load priority, the electrical power switching apparatuses may select 710 loads to apply power. The electrical power switching apparatuses may monitor and report 704 power of the loads. The loads may be cycled based on priority and power changes while the utility power is out. For example, after a load with a first priority has received power for 10 minutes, the electrical power switching apparatuses may apply power to a load with a second priority. The electrical power switching apparatuses may determine 706 that the utility power is restored and shutoff 712 the emergency backup power.

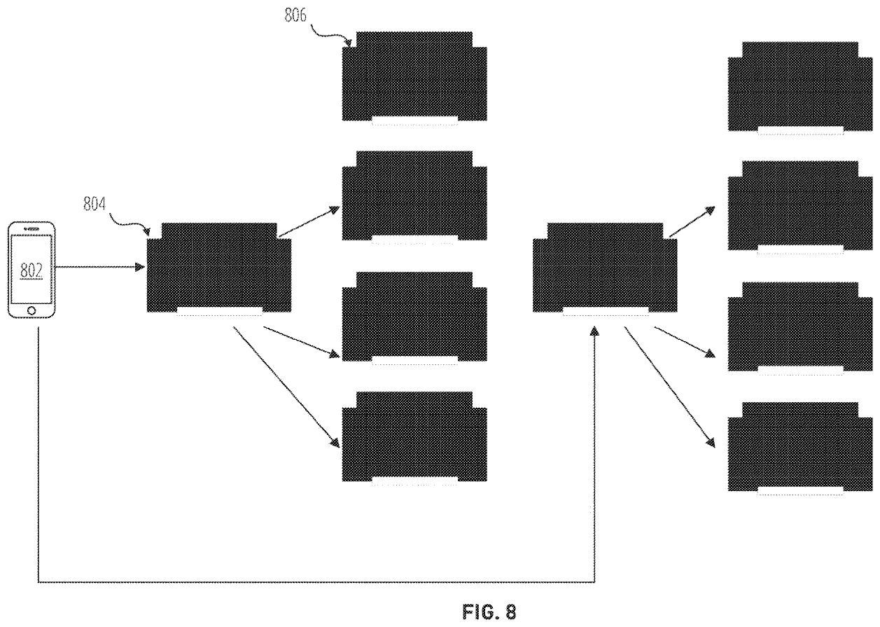

FIG. 8 illustrates an embodiment where multiple electrical power switching apparatuses 806 are connected to an electrical power switching apparatus serving as a hub 804. The hub 804 may control power to a load and communicate with a User Equipment (UE) 802 through wireless communication such as Bluetooth or Wi-Fi. Additionally, the hub 804 may control multiple electrical power switching apparatuses 806 simultaneously. One or multiple electrical power switching apparatuses 806 may be connected to a hub 804 and one or more hubs 804 may be connected to the UE 802. Many different UEs may be used to control the hubs such as phones, laptops, tablets, computers, and control screens. The switching hub 804 may be configured to transmit control commands to the one or more switching apparatuses 806. The control commands may configure the one or more switching apparatuses 806 to selectively apply power from a circuit breaker to one or more associated loads. The hub 804 may be configured to compile data (e.g., power consumption, faults, etc.) from the other electrical power switching apparatuses 806 and itself, and send information regarding the complied monitoring data to an external device.

In some embodiments, the hub 804 may determine load profiles for each of the additional smart electrical power switching apparatuses 806, and source profiles for one or more power sources. The hub 804 may determine which of the one or more associated loads to supply power to based on the load profiles, the source profiles, and the load priority.

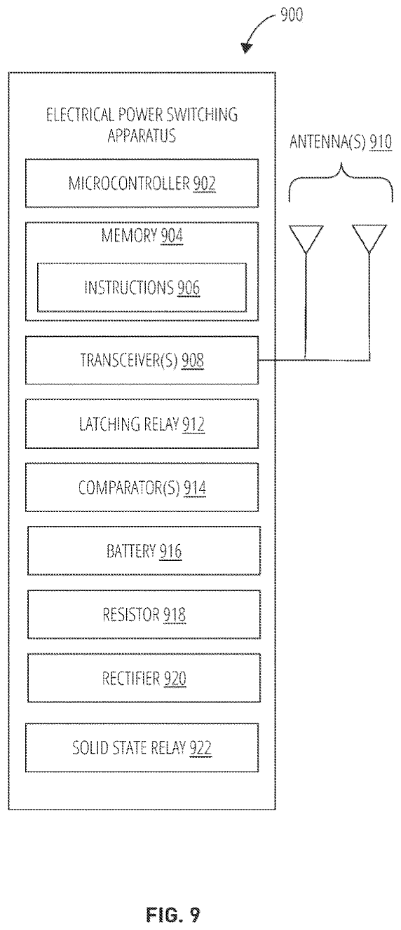

FIG. 9 illustrates a simplified block diagram of an electrical power switching apparatus 900 according to embodiments disclosed herein. The electrical power switching apparatus 900 may include a microcontroller 902. The microcontroller 902 may execute instructions such that various operations of the electrical power switching apparatus 900 are performed, as described herein. The microcontroller 902 may include one or more processors implemented using, for example, a central processing unit (CPU), an application specific integrated circuit (ASIC), a controller, a field programmable gate array (FPGA) device, another hardware device, a firmware device, or any combination thereof configured to perform the operations described herein.

The electrical power switching apparatus 900 may include a memory 904. The memory 904 may be a non-transitory computer-readable storage medium that stores instructions 906 (which may include, for example, the instructions being executed by the microcontroller 902. The instructions 906 may also be referred to as program code or a computer program. The memory 904 may also store data used by, and results computed by, the electrical power switching apparatus 900. In some embodiments, the instructions may cause the microcontroller 902 to execute various functions, such as: measurement of power, voltage, or current, switching loads from utility to emergency power, charging batteries, starting and stopping generators for power usage and exercising, managing the charging of batteries, reporting generator run time for servicing and refueling, providing usable photovoltaic electricity for emergency power when the utility grid is off and supplemental power when desired, provide load-shedding according to preset or selected priority within the capabilities of a given power source, such as but not limited to a solar array, battery storage bank, fuel generator, wind generator to meet and manage a given power sources out-put capabilities and/or utility power out-put loads.

The electrical power switching apparatus 900 may include one or more transceiver(s) 908 that may include transmitter and/or receiver circuitry that use the antenna(s) 910 of the electrical power switching apparatus 900 to facilitate signaling to and/or from the electrical power switching apparatus 900 with other devices. The transceiver(s) 908 may include a Bluetooth transceiver used to interface with smartphone to allow user preferences to be set and display power usage. The electrical power switching apparatus 900 may include RF amplifiers, filters, and matching networks for the transceiver(s) 908. The electrical power switching apparatus 900 may also include other wireless transceivers (e.g., WIFI). In some embodiments, the transceiver(s) 908 may be used to wirelessly switch a generator or other power sources on or off.

The electrical power switching apparatus 900 may include one or more antenna(s) 910. The antenna(s) 910 may be used to transmit and receive information to and from the user, receive commands for transferring power, and load shedding. The 910 may also wirelessly communicate to backup power sources to turn on and off other sources of power. Wireless signals may be communicated to and from the antenna(s) 910 of the electrical power switching apparatus 900, such as: Amps, Volts, kW, switching loads from utility to emergency power, charging batteries, starting and stopping generators for power usage and exercising, managing the charging of batteries, reporting generator run time for servicing and refueling, providing usable photovoltaic electricity for emergency power when the utility grid is off and supplemental power when desired, provide load-shedding according to preset or selected priority within the capabilities of a given power source, such as but not limited to a solar array, battery storage bank, fuel generator, wind generator to meet and manage a given power sources out-put capabilities and/or utility power out-put loads.

The electrical power switching apparatus 900 may also include a latching relay 912. The latching relay 912 may be a mechanical relay used for switching from utility power to other power sources. The electrical power switching apparatus 900 may also include one or more comparator(s) 914. The comparator(s) 914 may be used to detect power loss and turn on battery power to supply with electrical power switching apparatus 900 with power to carry out its intended function(s). The electrical power switching apparatus 900 may include a battery 916. The battery 916 may be used to power the electrical power switching apparatus 900 during power transferring times when both power sources are not active for brief periods of time. The electrical power switching apparatus 900 may include a resistor 918. Voltage may be read across the resistor 918 to calculate power usage. The electrical power switching apparatus 900 may include a rectifier 920. The rectifier 920 rectifies AC power to DC Power from the common 120-volt terminal and the neutral terminal or 240 volts from the common terminal and the common terminal. The electrical power switching apparatus 900 may include a solid state relay 922 for switching the load on and off.

The electrical power switching apparatus 900 can provide circuit switching to a no power position when overloaded with amps above a preset limit and add protection to a circuit breakers load by adding GFCI and AFCI protection. Because the electrical power switching apparatus measures amps, volts and kW, it can report faults and status conditions such as appliance overload conditions, maintenance needs and schedules, on and off conditions and accumulating watts for user privileges, via WIFI.

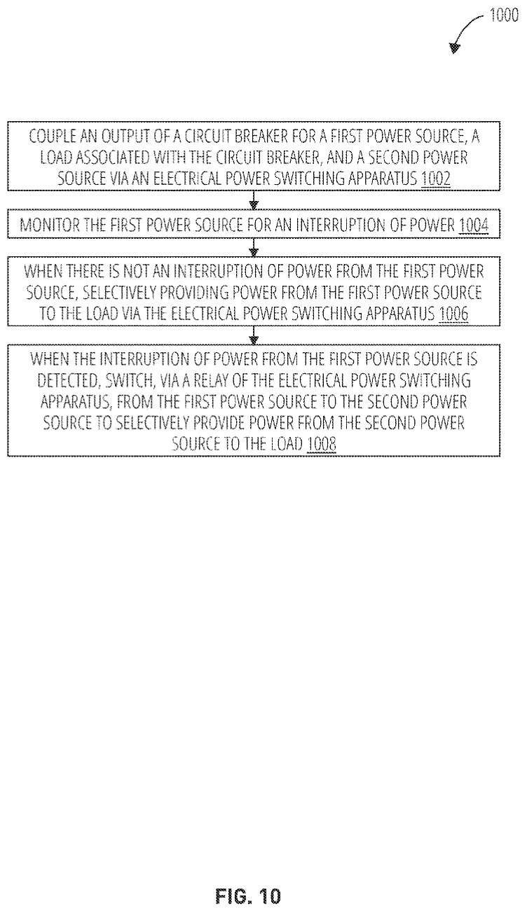

FIG. 10 illustrates a flowchart of a method 1000 of automatically switching an electrical load from one circuit to another circuit. The method comprises coupling 1002 an output of a circuit breaker for a first power source, a load associated with the circuit breaker, and a second power source via an electrical power switching apparatus. The method further comprises monitoring 1004 the first power source for an interruption of power. The method further comprises selectively providing 1006 selectively providing power from the first power source to the load when there is not an interruption of power from the first power source via the electrical power switching apparatus. The method further comprises switching 1008, via a relay of the electrical power switching apparatus, from the first power source to the second power source to selectively provide power from the second power source to the load when the interruption of power from the first power source is detected.

In some embodiments, the method further comprises receiving, via a wireless transceiver of the electrical power switching apparatus, user input specifying a load priority. In some embodiments, the method further comprises cycling power to the load based on the load priority.

The methods disclosed herein may include using any of the smart electrical power switching apparatuses or components thereof disclosed herein. The method may include performing any of the acts for managing electrical power, selective load control (e.g., shedding), or preparing and utilizing a circuit breaker panel for use with the electrical power switching apparatuses disclosed herein.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended Claims.

1. A smart electrical power switching apparatus comprising:
a housing sized and shaped to fit into a circuit breaker panel, the housing comprising:
mechanically held-latching contacts that are formed into the shape of busbar connectors of a circuit breaker, the mechanically held-latching contacts configured to stab or bolt into a circuit breaker panel to contact an electrical panel; and
a first electrical interface to couple to an output of the circuit breaker, wherein the first electrical interface receives an output power from the circuit breaker, wherein the apparatus is powered via the output power of the circuit breaker;
a second electrical interface to couple to a load associated with the circuit breaker;
a relay electrically coupled to the first electrical interface and the second electrical interface;
a wireless transceiver configured to communicate with external devices; and
processing circuitry configured to control the relay to selectively apply the output power from the circuit breaker to the load.

2. The apparatus of claim 1, wherein the mechanically held-latching contacts are non-conductive.

3. The apparatus of claim 1, wherein the wireless transceiver is configured to transmit control commands to one or more additional smart electrical power switching apparatuses, the control commands to configure the one or more additional smart electrical power switching apparatuses to selectively apply power from a circuit breaker to one or more associated loads.

4. The apparatus of claim 3, wherein the processing circuitry receives, via the wireless transceiver, user input specifying a load priority, wherein the control commands are based on the load priority.

5. The apparatus of claim 3, wherein the apparatus acts as a hub for the one or more additional smart electrical power switching apparatuses, wherein the one or more additional smart electrical power switching apparatuses send monitoring data to the wireless transceiver, and the processing circuitry compiles the monitoring data.

6. The apparatus of claim 5, wherein the processing circuitry is configured to send, via the wireless transceiver information regarding the complied monitoring data to the external device.

7. The apparatus of claim 5, wherein the processing circuitry is configured to:
determine load profiles for each of the additional smart electrical power switching apparatuses, and source profiles for one or more power sources;
determine which of the one or more associated loads to supply power to based on the load profiles, the source profiles, and the load priority.

8. The apparatus of claim 1, wherein the processing circuitry is configured to perform one or more of Automatic Transfer Switching, control, load management, and load monitoring.

9. The apparatus of claim 1, further comprising:
a third electrical interface to couple to a second power source, and
a mechanically latching relay to switch between the output of the circuit breaker and the second power source.

10. The apparatus of claim 1, further comprising a signal amplifier antenna mounted to the circuit breaker panel, wherein the signal amplifier antenna wirelessly receives a signal from the wireless transceiver.

11. The apparatus of claim 1, further comprising a rail mounting slot.

12. The apparatus of claim 1, further comprising one or more adapter plates configured to couple with the housing.

13. A smart electrical power switching system comprising:
a switching hub in communication with an external device; and
one or more switching apparatuses in communication with the switching hub,
wherein the switching hub and the one or more switching apparatuses each comprise:
a housing sized and shaped to fit into a circuit breaker panel, the housing comprising:
mechanically held-latching contacts that are formed into the shape of busbar connectors of a circuit breaker, the mechanically held-latching contacts configured to stab or bolt into a circuit breaker panel to contact an electrical panel; and
a first electrical interface to couple to an output of the circuit breaker, wherein the first electrical interface receives an output power from the circuit breaker, wherein the apparatus is powered via the output power of the circuit breaker;
a second electrical interface to couple to a load associated with the circuit breaker;
a relay electrically coupled to the first electrical interface and the second electrical interface;
a wireless transceiver; and
processing circuitry configured to control the relay to selectively apply the output power from the circuit breaker to the load.

14. The system of claim 13, wherein the mechanically held-latching contacts are non-conductive.

15. The system of claim 13, wherein the switching hub is configured to transmit control commands to the one or more switching apparatuses, the control commands to configure the one or more switching apparatuses to selectively apply power from a circuit breaker to one or more associated loads.

16. The system of claim 15, wherein the processing circuitry receives, via the wireless transceiver, user input specifying a load priority, wherein the control commands are based on the load priority.

17. The system of claim 15, wherein the hub is configured to send, via the wireless transceiver information regarding complied monitoring data to the external device.

18. The system of claim 15, wherein the processing circuitry is configured to:
determine load profiles for each of the additional smart electrical power switching apparatuses, and source profiles for one or more power sources;
determine which of the one or more associated loads to supply power to based on the load profiles, the source profiles, and a load priority.

19. The system of claim 13, wherein the switching hub and the one or more switching apparatuses each further comprise one or more adapter plates configured to couple with the housing.

20. The system of claim 13, wherein the processing circuitry is configured to perform one or more of Automatic Transfer Switching, control, load management, and load monitoring.

21. A method of automatically switching an electrical load from one circuit to another circuit, the method comprising:
coupling an output of a circuit breaker for a first power source, a load associated with the circuit breaker, and a second power source via an electrical power switching apparatus;
monitoring the first power source for an interruption of power;
when there is not an interruption of power from the first power source, selectively providing power from the first power source to the load via the electrical power switching apparatus; and
when the interruption of power from the first power source is detected, switching, via a relay of the electrical power switching apparatus, from the first power source to the second power source to selectively provide power from the second power source to the load.

22. The method of claim 21, further comprising receiving, via a wireless transceiver of the electrical power switching apparatus, user input specifying a load priority.

23. The method of claim 22, cycling power to the load based on the load priority.

24. The method of claim 22, wherein the electrical power switching apparatus comprises a housing sized and shaped to fit into a circuit breaker panel, the housing comprising non-conductive mechanically held-latching contacts that are formed into the shape of busbar connectors of a circuit breaker, the mechanically held-latching contacts configured to stab or bolt into a circuit breaker panel to contact an electrical pane.
